(19) United States
(12) Patent Application Publication
(10) Pub. No.: US 2018/0161793 A1
(43) Pub. Date: Jun. 14, 2018

(54) SMART MULTI-PORT FLUID DELIVERY SYSTEM

(71) Applicant: Peter Disimile, Cincinnati, OH (US)

(72) Inventor: Peter Disimile, Cincinnati, OH (US)

(73) Assignee: Engineering & Scientific Innovations, Inc., Fairfield, OH (US)

(21) Appl. No.: 15/808,917

(22) Filed: Nov. 10, 2017

Related U.S. Application Data
(60) Provisional application No. 62/405,313, filed on Oct. 7, 2016.

(51) Int. Cl. B05B 12/12; A62C 3/08; A62C 31/05; A62C 37/36; B05B 1/16; A62C 37/40; B64D 15/10

(52) U.S. Cl. CPC B05B 12/12; A62C 3/08; A62C 31/05; B64D 15/10; B05B 1/169; A62C 37/40; A62C 37/04

(57) ABSTRACT

A smart fluid application system and method for the delivery of a fluid to a discreet location is disclosed in the present application. The system and method utilize a rigidly affixed port block with multiple discharge ports, where each port has at least two apertures, all of which are positioned and designed to dispense a fluid only to a pre-determined location. At least one sensor detects an event and directs the release of fluid through a specific port and ceases the release when the event is ended. Such a system and method may be used anywhere a precise application of fluid is required.

### CROSS REFERENCE TO RELATED APPLICATIONS

This patent application claims the benefit of provisional patent application Ser. No. 62/405,313 filed Oct. 7, 2016 by the present applicant, the disclosure of which is hereby incorporated by reference in its entirety

### BACKGROUND

In many daily applications there is a need to rapidly and efficiently deliver a fluid to a pre-identified local area of a surface or region in space. Yet, in most cases, the fluid is delivered by flooding the area or region of interest, eventually providing the required coverage. Unfortunately, this results in uneven levels of fluid deposition or concentration levels in some regions and insufficient deposition or concentration levels in others. This proves to be inefficient, wasteful, and in some applications, results in the unnecessary spread of dangerous or toxic products. Applications may simply involve the watering of grass and plants in a suburban home, spraying of deicing chemicals on the wings of aircraft at the local airport, insecticide spraying on a farm, the injection of fire suppressants in an attempt to extinguish a fire or the process of thermal cooling of electrical and electronic components to prevent overheating, such as those found in telecommunications and computers spaces.

Although there are some complicated mechanical mechanisms which may be capable of moving or articulating a fluid nozzle to an area of interest, these devices tend to bulky and have many operational problems. Further, with these devices, although they may incorporate some limited feedback, there is no real time intelligence integrated into the device or the ability to evaluate the local conditions to ascertain when enough fluid has been delivered in real time. In some applications, the time response is critical to the effectiveness of the fluid delivery system.

The potential for accidental or intentional ignition in or around aircraft dry bays and engine nacelles remains a high-level threat to commercial and military aircraft survivability. Typical aircraft dry bays and engine nacelle regions contain critical components essential to the safe operation of the aircraft such as hydraulic and fuel lines, avionics, and electrical wiring. However, the combination of these elements presents multiple potential fire scenarios, which can be categorized as either accidentally or intentionally induced threats. For example, an intentional threat may consist of the rupture of a fuel tank due to a ballistic impact, causing a spray of burning fuel into an adjacent dry bay which can result in critical damage to surrounding components. On the other hand, an accidental threat may consist of a fuel line leak within an engine nacelle due to component fatigue, which then ignites on a hot surface of the engine core. Fire protection within these vulnerable regions is, therefore, paramount due to the numerous fuel and ignition sources that are present. As a result of the inherently different fire scenarios, different suppression systems are often employed for each region, each of which require a system capable of rapidly discharging a fire suppressant that effectively mixes with the fire. While passive technologies are often employed in dry bay protection systems, active halon suppression systems are often used in engine nacelle regions. In both scenarios, it has been determined that the overall protection benefit of increasing the effectiveness and efficiency of these systems far outweighs the cost of the system. The production ban on halogenated agents and the relative inefficiency of replacement agents further highlights the need for a technology which can increase the overall system efficiency of both types of systems. Therefore, the need arises for a smart fluid fire protection system which would rapidly detect a fire and discharge agent with an improved delivery mechanism, allowing not only a low cost replacement for current systems, but availability for integration in the design of future aircraft as well.

For the past several decades, halogenated agents, notably halon 1301, have protected aircraft engine nacelles and some dry bays regions. Since the production ban on halon, scientists and engineers in the public and private sectors have been working on replacement agents and new technologies that attempt to achieve the efficiency of halon agents. For instance, innovative passive fire suppression technologies are being implemented into dry bay areas as an alternative to legacy halon systems, while the chemical industry is attempting to increase the efficiency of new halon replacement agents. Thus far, none of the systems or agents has succeeded completely in achieving the desired efficiency. The technologies (passive or active) and new suppressants that have been deemed acceptable, when based on environmental friendliness, toxicity, materials compatibility, etc., have all lacked fire-suppression efficiency as measured by weight and/or volume. To improve the fire-suppression efficiency of the candidate agents and technologies, one area of focus is suppressant distribution. For example, legacy halon 1301 systems were so effective (due to the supreme efficiency of halon 1301), research into understanding the suppressant delivery, especially in highly cluttered regions, offered little payoff. However, since the new replacement agents are less effective than halon 1301, suppressant transport is now a critical issue. Even the new innovative passive technologies are less effective compared to the legacy systems they are attempting to replace. In fact, most suppression systems (active and passive) do not incorporate discharge nozzles at all, but rather simply dump suppressant in an incredibly inefficient manner. With the lack of efficiencies in candidate technologies, increasing the agent delivery efficiency can have a large payoff in reducing the design time and/or weight of a fire protection system.

Over the last 10 years, the fire protection industry has been trying to move away from total flooding suppression systems toward systems with directed agent delivery system, as a method to increase system efficiency and reduce collateral damage. For instance, the US Navy has shifted from full-flooding systems for shipboard applications, to a highly directed water delivery system for their next generation fleet. These newer systems incorporate computer controlled tele-robotic nozzles, to direct agent at the fire region. This tele-robotic nozzle technology is on the forefront of the fire protection industry. However, shipboard applications have minimal concerns with the weight of fire suppression systems. As such, these tele-robotic nozzle systems are bulky and too heavy for consideration for aircraft platforms.

Aircraft platforms require fire protection systems optimized with minimal size and weight. For example, engine nacelle regions, which have the highest susceptibility to aircraft fires, contain a high level of clutter (fuel lines, wire bundles, etc.) within a compact space. This clutter blocks suppressant delivery and acts as a flame holder, shielding fires from suppression systems. As a result, a directed agent delivery would be preferred for this fire region, with the nozzles optimally placed to sufficiently protect the high risk regions. However, installation of the directed agent nozzles in an engine nacelle region is difficult due to the combination clutter in a confined space. As a result, fire protection systems within engine nacelles will have to be installed between clutter elements to achieve the most efficient agent delivery. Therefore, a device is needed that must not only be sufficiently small in size, but ideally would remain in a fixed position as to allow installation within the cluttered engine nacelle regions. By designing the proposed technology to meet the critical criteria necessary for engine nacelles, such a device and system would offer more than acceptable performance in dry bay areas which have increased size, less clutter and are less susceptible to fires.

Therefore, the need exists for a smart system with some limited directional discharge capability to be available to installation in both new and legacy aircraft, which can automatically locate the fire (or other event) region and discharge suppressant (or other fluid) directly at the fire zone and not require total flooding of the region to be protected. This system must be capable of installation in a tight space requirement, with minimal weight added, but also capable of protecting larger dry bay regions. Furthermore, this technology should not rely on a specific agent to achieve its effectiveness, since replacement systems use many separate agents. To this end, the current solution of a lightweight, self-contained Smart Multi-Port Fire Suppressor (Smart MPFS) which is capable of locating a fire and discharging agent directly at the fire within 100 millisecond (ms), while remaining in a fixed installation position is presented.

### SUMMARY

The presented system offers a unique combination of quick response and efficient mixing due to the discharge port and aperture design. The extinguishing capability is superior to what is currently on the market. This system is simpler and more efficient than current suppressant systems. In certain embodiments the Smart MPFS does not have a camera or complicated computing and locating algorithm. The “Smart MPFS” has multiple (more then one) ports that are fixed in space and directed to a single pre-selected location or region in space. The specific spatial locations that need to be protected are known and the discharge port is fixed to that location. As stated, the Smart MPFS has discharge port(s) with multiple apertures whose geometry, spacing, and number are application dependent. The system is very versatile since it can be designed to accommodate a near limitless number of spatial areas and can be adapted to the type of expected event or coverage needed.

By incorporating an optical fire location module with a unique discharge nozzle, the newly developed Smart Multi-Port Fire Suppressor will be capable of locating a fire and discharging agent directly to the fire zone within 100 ms of receiving an external detection signal. This Smart Multi-Port Fire Suppressor (Smart MPFS) will thereby increase the overall efficiency of the suppression system by increasing the coverage area of a single discharging port, reducing the number of nozzles required and decreasing the amount of agent required to extinguish a fire, all while reducing collateral damage to nearby areas not affected by the fire. It is anticipated that the presented system can be employed to detect and apply a fluid in response to a variety of events including fire suppression. An anticipated system would have proper sensors and fluids capable of detecting the specific event and performing the function desired such as coating, de-icing, altering or fire suppression.

### DRAWINGS—FIGURES

FIG. 1 is an overall perspective view of a fire suppression embodiment of the smart multi-port fluid delivery system.

FIG. 2 is an overall perspective view of a fire suppression embodiment of the smart multi-port fluid delivery system showing the discharge ports of the system.

FIG. 3 is an overall perspective view of a fire suppression embodiment of the smart multi-port fluid delivery system showing the discharge ports and sensor assembly of the system.

FIG. 4 is a front view of a fire suppression embodiment of the smart multi-port fluid delivery system.

FIG. 5 is a rear view of a fire suppression embodiment of the smart multi-port fluid delivery system.

FIG. 6 is a side view of a fire suppression embodiment of the smart multi-port fluid delivery system.

FIG. 7 is a top view of a fire suppression embodiment of the smart multi-port fluid delivery system.

FIG. 8 is a bottom view of a fire suppression embodiment of the smart multi-port fluid delivery system.

FIG. 9 is an isometric view of an embodiment of the discharge port of the smart multi-port fluid delivery system showing the port face.

FIG. 10 is an isometric view of an embodiment of the discharge port of the smart multi-port fluid delivery system showing the interior of the port from the side opposite the port face.

FIG. 11 is a view of the port face of an embodiment of the smart multi-port fluid delivery system showing elliptical apertures in a star pattern.

FIG. 12 is a view of the back end of a discharge port of an embodiment of the smart multi-port fluid delivery system showing elliptical apertures in a star pattern.

FIG. 13 is a cut away view AA of the embodiment of the discharge port shown in FIG. 11.

DRAWINGS - Reference Numerals

| | |
|---|---|
| 10. fluid delivery system | 20. port block. |
| 30. discharge port | 31. discharge port face |
| 32. discharge port face center point | 33. discharge port side |
| 34. aperture | 35. fluid channel |
| 36. fluid channel outer end | 37. fluid channel inner end |
| 38. dispersal cone | 39. port cavity |
| 40. sensor assembly | 42. area sensor |
| 44. local sensor | 50. driving fluid manifold |
| 52. driving fluid line | 54. solenoid |

### DETAILED DESCRIPTION

The proposed embodiment of the Smart MPFS consists of three primary components: a fire (or other event in other embodiments) detection module, a multi-port discharge block and a port activation mechanism. The Smart MPFS utilizes a unique arrangement of discharge ports, which provides enhanced mixing effectiveness that allows the discharging agent to rapidly penetrate deep into a fire (or other event) zone without prolonged discharge. Simultaneous activation of multiple discharge ports can occur per fire (or other) event to create sufficient agent coverage of which cannot be obtained using conventional systems. An electrical switching mechanism controls the flow of agent from its supply to the activated discharge ports, while the optical fire locating system determines the number of ports needed to cover the fire zone. Upon receiving a detection signal or signals, the fire locating system determines the spatial location of the fire region and activates the appropriate discharge port or ports via the switching mechanism, thereby directing agent toward the fire zone and extinguishing the fire while minimizing damage to nearby areas. Some of above locating, switching and valve features were included in a previous patent application US2016/0059057, filed on Sep. 10, 2015 by the applicants, the disclosure of which is incorporated by reference in its entirety. Further details of each of the Smart MPFS components are provided in the following subsections. As an example, an anticipated use of the system in fire suppression, is presented below to illustrate the features of the fluid distribution system.

### Fire Detection and Locating Assembly

Each port of the Smart MPFS is independently controlled by a separate infrared (IR) detector and is integrated into a universal ultraviolet (UV) electro-optic module. In other applications different sensors may be utilized including ones that detect motion, moisture and odor. In certain embodiments one sensor may detect the event for all of the sensors. Cameras may be utilized as well.

Fire Protection Example:

This example employs a UV sensor, which covers the entire area protected by the system and an IR sensor focused on a particular discreet region in the overall area. Only when both of these two sensors indicate the presence of a fire is a signal transmitted to the discharging mechanism, allowing for the discharge of fluid through the appropriate ports and thereby delivering fire suppressant to only that region. In a similar way in a coating or de-icing application, such as an aircraft wing, sensors would inspect the wing for the presence of ice and discharge de-icing fluid to the zone only.

### Discharging Fluid Control

An individual discharge port consists of an arrangement of multiple apertures made to interact and spread the resulting single or multiple phase (fluids can contain solid, liquid, and gas) jets. The actual number of ports, port spacing and relative angles of each port are determined for each application, however each port and aperture will be of sufficient size such that fouling or blockage is not a concern. The apertures and ports may be configurations and geometries that are known to those experienced in the art.

It has been determined that non-circular geometries, and particularly elliptical apertures arranged multiply in a circular configuration are very effective in fire suppression. The apertures define the end of channels of the same cross sectional geometry of the apertures that pass through the ports and link up with the fluid supply with in the body of the system. The apertures are found on the face of the port and may be arranged in a circular, star or flower shaped pattern around the center of the port face. The channels communicating with the apertures project back into the port toward a fluid source.

In one embodiment, the port comprises multiple elliptically shaped (in cross-section) apertures that are the termini of channels which may also be elliptical in cross section. The apertures are arranged symmetrically around the center of the port face in a star shaped pattern. The channels project back from the port face into the interior of the port. The channels are slightly angled outward from the center line of the port as they travel back into the port. The channels terminate at a point inside of the port in a chamber where a conical projection positioned in the middle of the channels. The conical projection points away from the channels and toward the fluid source and acts to direct the fluid into the individual ports. The chamber may contain a powdered fire suppressant or other fluid that is expelled by the driving fluid. It has been determined that alone, or in combination the elliptical apertures arranged in a round geometry and the angled channels produce a swirling of the fluid upon exit from the port resulting in superior fire suppression. The non-circular, including elliptical cross-section create velocity, flow and pressure differentials in the fluid output as opposed to a circular or round aperture resulting in swirling and improved fluid mixing.

In other embodiments, the channels may twist around a central axis originating at the center of the port face and terminate at the junction of the port and the port block or body of the system. The channels may be at angles not parallel with the out side wall the central axis of the port. The channels may twist about their own individual central axes. A mixing or directional cone may be present at this point to assist in the distribution of the fluid to each of the channels. The ports may be oriented at different angles and can be fired independently or in multiples. The size (length) and aperture geometry of the ports are variable and are predetermined based on the location of the target and the amount of fluid that has to be delivered to the target zone. It is also anticipated that individual apertures or multiple apertures on a given port may be chosen and individually disperse fluid.

The discharge port can be machined or three-dimensional printed. The ports and apertures will be designed and positioned to specifically protect a certain area of a space or location. The sensors will detect an event in a certain area and trigger the release of fire suppressant agents (for example) to that area until the event is over. The Smart MPFS unit typically remains in a static position. The direction of suppressant discharge is determined by the sensors and subsequent port choice. Due to the nature of this discharge port design, it is expected that an optimal discharge aperture size can be successfully determined to allow passage of all classes of fire suppressant agents, including but not limited to: Dupont FM-200 and FE-25, water, carbon dioxide, nitrogen, potassium bicarbonate, monoammonium phosphate, CO₂/potassium bicarbonate, and sodium bicarbonate. The discharge port may be attached to a port selector block which is connected directly to the suppressant supply.

Multiple port technology proposed for the current system has been successfully demonstrated to be capable of directing the exiting agent jet, with a fixed nozzle housing position. Furthermore, since the CO₂/potassium bicarbonate agent utilized is a powder/gas mixture representing the largest size of most fire suppression agents, this MPFS can achieve similar success with other smaller sized agents. It is also important to note that the shift demonstrated utilizing the multiple port nozzles did not adversely affect the distribution in the discharged jet, which is not easily achieved using a single port discharge mechanism.

The switching mechanism may consist of a valve, such as an electro-mechanical valve (solenoid valve) arrangement for each discharge port. The valve can be operated in the on/off mode. The valve has a mechanism that controls the amount of fluid that can pass through the valve body and exit a specific discharge port through its apertures. The amount of fluid to be discharged through the valve depends on the thermodynamic properties of the fluid, the pressure and temperature of the fluid upstream of the valve and the open area of the valve through which the fluid will pass. When the valve is operated in the isolation mode the valve can be either open or closed. The solenoid valve may release a gas or other fluid that drives a suppressant powder, the source of which may be positioned with in the discharge port or along the course of the driving fluid with the body of the system, which is applied to a fire event. The fluid may be the fire suppressant itself.

It is anticipated that this system may be used in any case where fluid is desired to be applied to a specific spot while limiting fluid and energy wastage. Such applications may include, but are not limited to, fire suppression, cooling, paint application, pesticide application, watering, coating, de-icing, steaming and heating. The control logic and hardware may be adjusted to detect and apply a needed fluid for such divergent applications. Relevant detection equipment (cameras and sensors) may be employed to sense events and software may be written to perform the required operations. The above system is very versatile and may be adjusted to meet the requirements of a multitude of applications where direct fluid application is needed.

As an example of the ESI Multi-Port Fire Suppressor (MPFS) system, a three port discharge design and a multi-wavelength fire detection capability was employed to rapidly detect and suppress large fuel fires. The MPFS system discharged agent directly into the fire zone which resulted in faster and more effective fire extinguishing than other currently fielded fire protection systems. The demonstrated unit contained 100 grams of Purple K (Potassium Bicarbonate) in each of its three discharge ports, for a total of 300 grams (0.66 lbs.) of fire suppressing agent. The suppressant was contained in three separate and easily reloadable cartridges for quick replacement after a fire event. The dry chemical powder was targeted to a predetermined region and driven by a compressed gas source. Current testing has utilized compressed air at 1,100 PSI, however, CO₂ or Nitrogen gas could be used in final commercialized units for enhanced suppression characteristics. Each discharge port of the MPFS is independently controlled by a separate infrared (IR) detector and is integrated into a universal ultraviolet (UV) electro-optic module. When both sensing circuits detect and validate a fire event, an electrically-controlled solenoid was energized, releasing the stored compressed gas. The unit continued to release driving gas until the sensors no longer detect a fire (fire is extinguished) or until the unit runs out of agent. Currently, the MPFS system, without the driving gas canister, weighs approximately 5 pounds.

### Current MPFS Testing

The MPFS has been evaluated against 300 gallon per hour (gph) fuel spray fires in a simulated space approximately equivalent in size to a rotorcraft main cabin. However, more extensive attempts have been focused on 150 gph fuel spray fires. In these tests, the fuel system delivered 150 gph of diesel fuel for 4.7 seconds. A series of five consecutive fire tests were conducted and demonstrated an ability of the MPFS to successfully extinguish the spray fires in an average of 1.573 seconds after the flame was first observed and then 1.007 seconds after agent delivery was initiated.

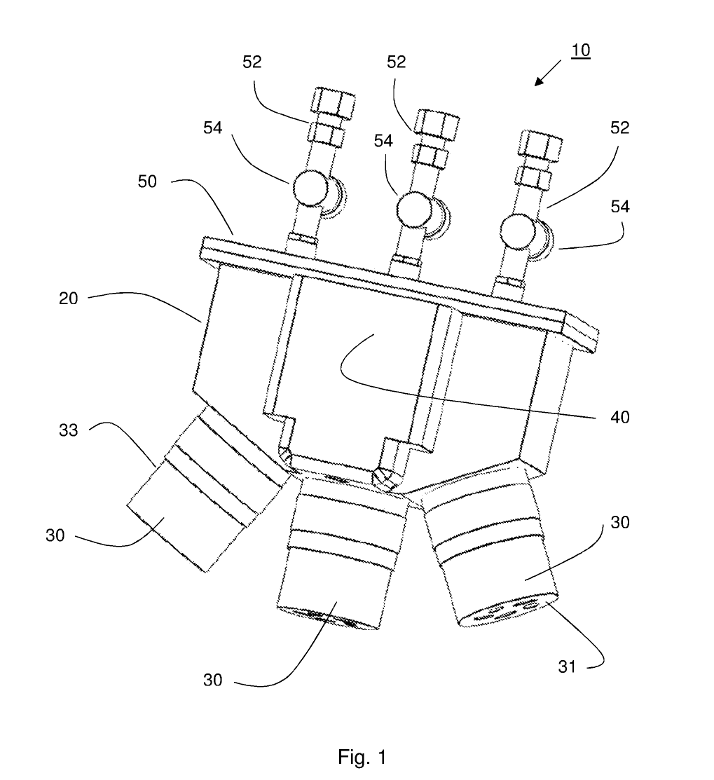

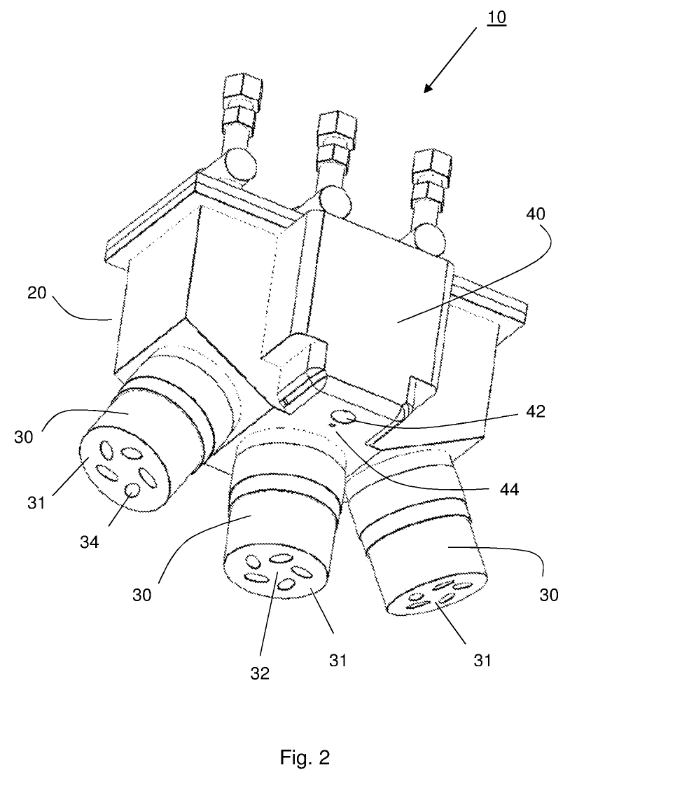

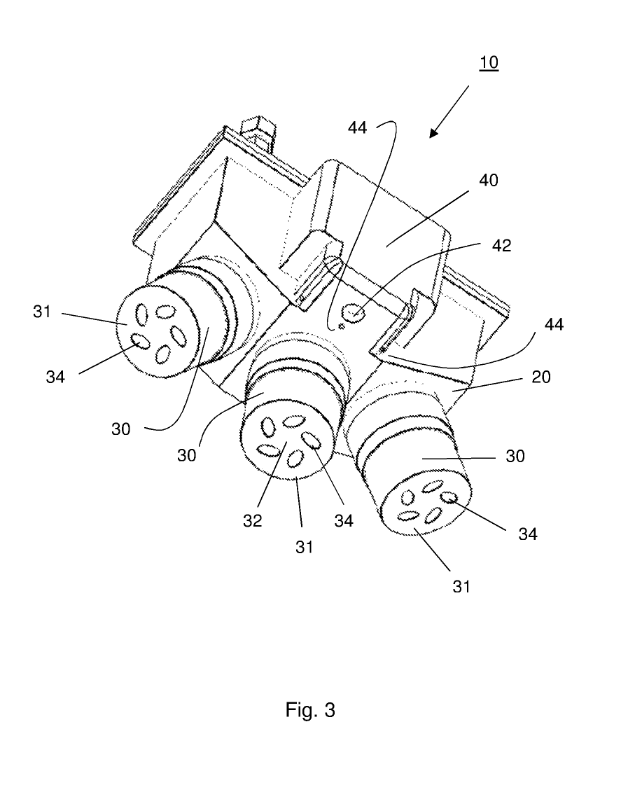

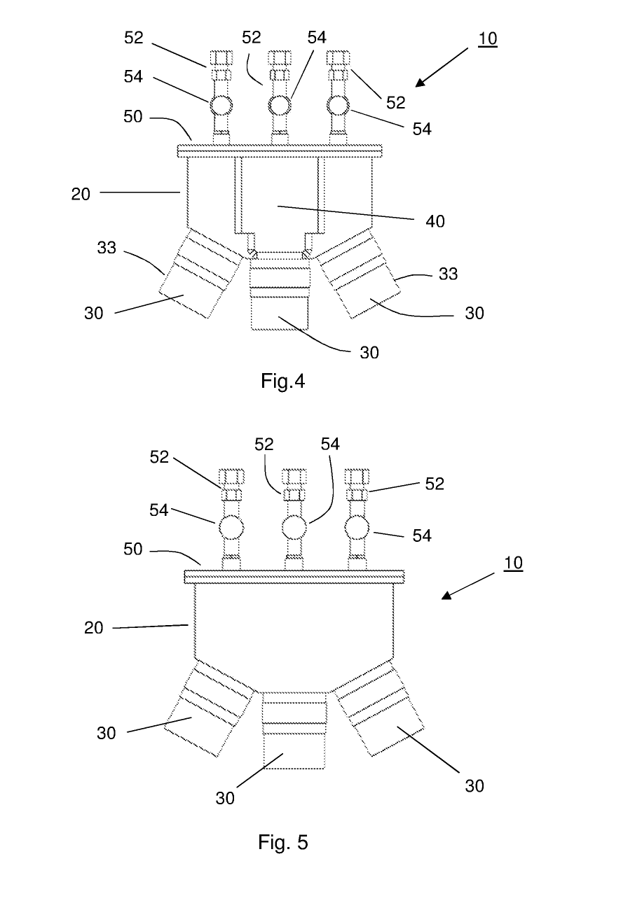

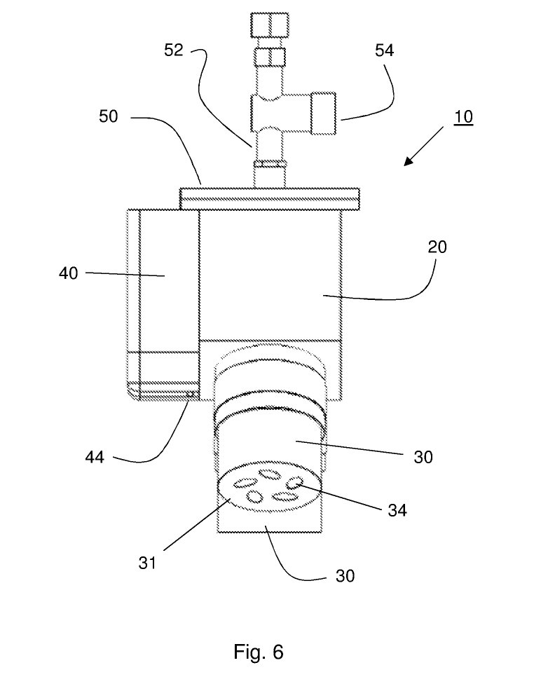

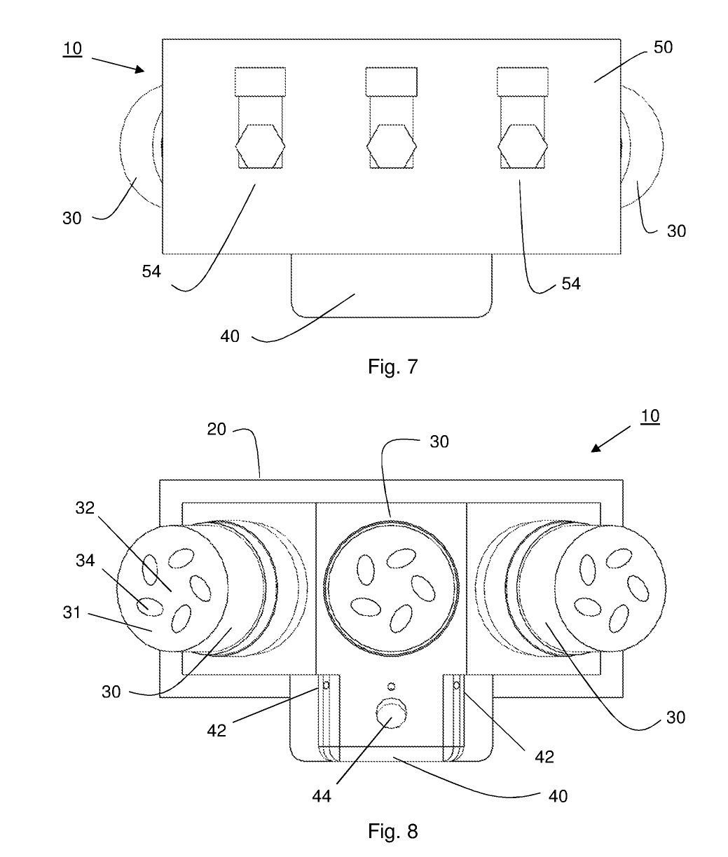

FIGS. 1-8 depict an embodiment of the Smart Multi-Port Fluid Delivery system used for fire suppression. Although this embodiment is intended for the detection and suppression of a fire related event, the features of the system are the same or similar to those from systems envisioned for other event applications. The system 10 is comprised of a port block 20 a driving fluid manifold 50 and a source of compressed gas or driving fluid (not pictured) such as a reservoir or fluid cell. A means to project the fluid (also not pictured) is connected to the source of the driving fluid such as a pump, pressurization or other device known in the art. The source of driving fluid is attached to the driving fluid manifold 50, the release thereof being controlled by solenoids 52.

The port block 20 is comprised of multiple discharge ports 30. Each port 30 has at least two apertures 34 communicating via a fluid channel between the port face 31 of each port 30, through the interior of the port block 20 and to and through the driving gas manifold 50 terminating at a dedicated solenoid 54. An individual solenoid 54 communicates with each port 30 and the apertures 34 of that specific port 30. A driving fluid line 52 runs from the fluid source into the gas manifold 50 and is interrupted in its length by a solenoid 54. A source of fluid or powdered fire suppressant may be found within the port block 20 or the port 30 itself for each of the ports 30 at a point along the fluid channel. The suppressant source may be refillable. In other embodiments the suppressant or other fluid to be applied may be supplied from the source of compressed gas itself or may be the projected compressed fluid from the gas source.

Each Multi-Port system 10 is intended to be designed for a specific area and event identification. Each system is designed to dispense a fluid on, or in, a defined overall area or location. Each port 30 is positioned and configured to apply a fluid on a specific part of the defined overall area. Together the all of the ports 30 will cover the overall area. The apertures 34 of the ports 30 are of a specific number, size, angle and shape to deliver the fluid to a specific location in response to a specific event. The amount of fluid and the pressure required to perform the desired function is also calculated for the block and specific event. Such factors are well known to those knowledgeable in the art.

The port block 20 has one area sensor 42 for the identification of an event, such as a fire in this embodiment. Local sensors 44 are dedicated to individual ports 30. In this fire suppression embodiment, the area sensor 42 is a ultra-violet (UV) sensor and the local sensor 44 is an infrared (IR) sensor. The area sensor 42 and the local sensors 44 are positioned on the sensor assembly 40 located on the port block 20. The area sensor 42 is configured to detect a fire event by its UV signature anywhere in the area of coverage of the unit 10. The local sensors 44 are positioned and designed to detect the IR signature of a fire at the specific and discreet area covered by the associated port 30. The UV signal detected by the area sensor 42 informs the logic board or an other computational device that a fire has been detected in the detectable area. If a local sensor 44 then detects an IR signal in the same time frame as the UV signal, then the logic board directs the solenoid 54 associated with the particular detecting local sensor 44 to open and release the driving fluid from and through the driving fluid line 52, through the manifold 50 and into the port block 20 to the appropriate port 30. The fire suppressant is then dispensed through the apertures 34 of the port 30 dedicated to cover the particular area where the event was detected.

The local sensor 44 associated with a particular port 30 will be aimed to detect the event in the location covered by that particular port 30. When the local sensor 44 senses the end of the event a signal is sent to the solenoid 54 to close thereby shutting off fluid flow through the driving fluid line 52. In this way, only the effected area is treated with the fluid and only so long as the event exists thereby protecting non-affected areas and limiting the use of suppressant and driving fluid. Also, if the area sensor 42 and the local sensor 44 do not sense the event at the same time no fluid will be dispensed.

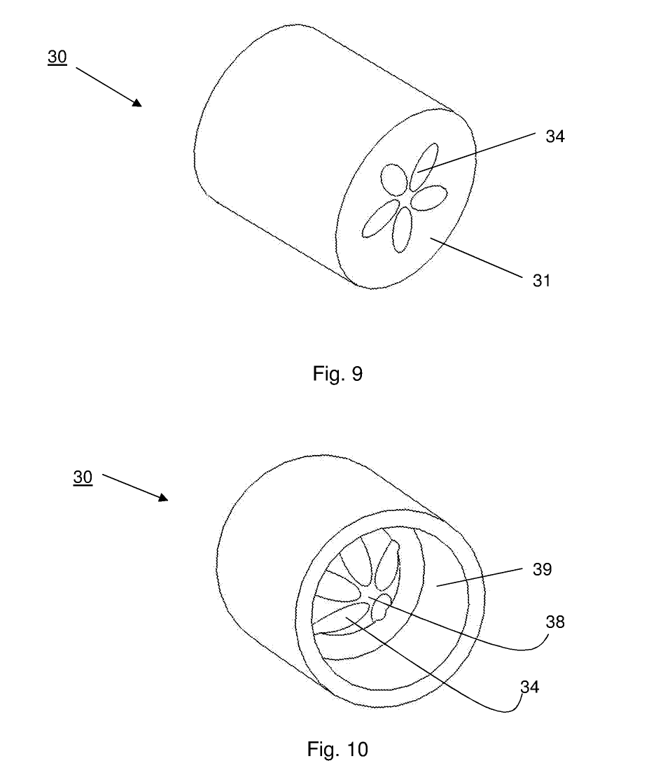

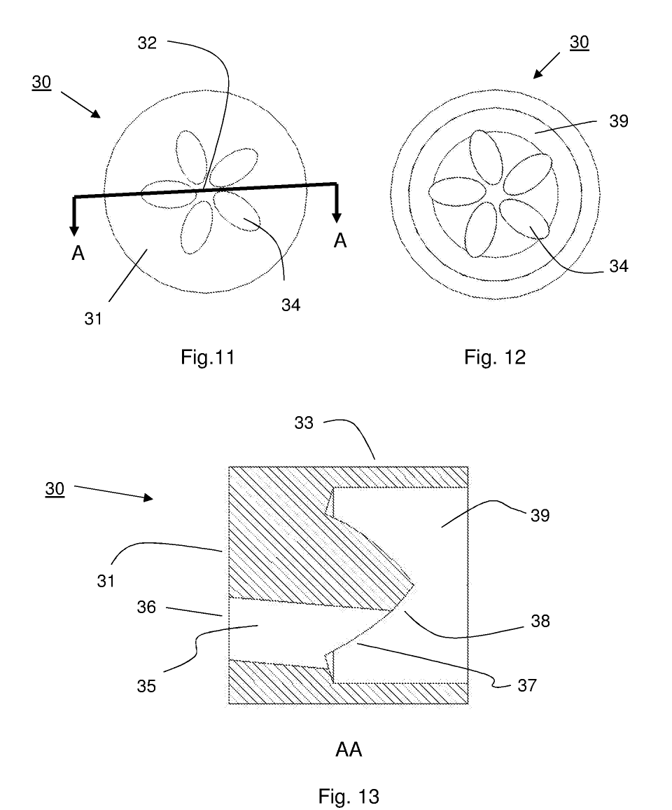

FIGS. 9-13 show more detailed views of the discharge port 30 of the fluid delivery system 10. The port 30 comprises multiple elliptically shaped (in cross-section) apertures 34 that are the termini of fluid channels 35 which may also be elliptical in cross section. The apertures 34 are arranged symmetrically around a center point 32 of the discharge port face 31 in a star shaped pattern. FIG. 13 is sectional view of a port 30 sectioned along a diameter of the port face 31 through to the side opposite the port face 31. The section line is showed on FIG. 11 and indicates a cut through one of the channels 35. The channel 35 projects back from the port face 31 into the interior of the port 30 and has an outer end 36 and an inner end 38. The outer end 36 terminates at the discharge port face 31 at an aperture 34. The inner end 37 terminates in the port cavity 39 inside of the port 30. The channel 35 is slightly angled outward from the center line of the port 30 as it travels back into the port 30. The remaining channels 35 are positioned in the same manner symmetrically around the center point 32 of the discharge port face 31. All of the channels 35 terminate at a point inside of the port 30 in the chamber 39 where a dispersal cone 38 is positioned in the middle of the arrangement of the inner ends 37 of the channels 35. The dispersal cone 38 points away from the channels and toward the fluid source and acts to direct the fluid into the individual channels 35. The chamber 39 may contain a powdered fire suppressant or other fluid that is expelled by the driving fluid.

### Operation

It is anticipated that this system may be used in any case where fluid is desired to be applied on a specific location while limiting fluid and energy wastage. Such applications may include, but are not limited to, fire suppression, cooling, paint application, pesticide application, watering, coating, de-icing, steaming and heating. The software and hardware may be adjusted to detect and apply a needed fluid for such divergent applications. The specific software, hardware, electronics and control elements for the control of the detecting and locating of an event as well as the selection of the proper port(s) and the release and shut of the fluid media are common to the art and can be based on a wide variety of computer languages and coding systems. Relevant detection equipment (cameras and sensors) may be employed to sense events and software may be written to perform the required operations. The above system is very versatile and may be adjusted to meet the requirements of a multitude of applications where direct fluid application is needed. Therefore, the scope of the structure should be determined by the appended claims and their legal equivalents, rather than by the examples presented.

The method employed for the delivery of fluid is straightforward with the present system. A sensor for a specific event (fire, moisture, ice, etc.) detects the event and sends an electrical signal to a valve or solenoid for a specific port that is positioned to discharge a fluid directly onto a specific location. Each port may have its own specific sensors or sensors may be shared between the ports. The location may be an area, space or volume. The port is designed with a required number of apertures sufficient to dispense a required amount of fluid to only the desired location. Once the event is over, the sensors will detect this, and the signal will end and the flow of fluid will stop. Only enough fluid to accomplish the goal, such as putting out a fire, will be dispensed. The system will have multiple ports to provide coverage over an area, but only those positioned to dispense onto the specific affected location will be activated, thus saving fluid and protecting non-affected locations. The amount of fluid necessary to meet a need may be great and the may be projected under strong pressure, but such will be determined by the requirements of the anticipated event.

A stated this method uses rigidly mounted fluid ports that are positioned in a pre-determined manner to dispense fluid on a specific area. When activated, the port always projects fluid out of all of the apertures passing through the port and connected to a fluid supply. Each port and its apertures are dedicated to a location. More than one port may be chosen for a large event, but all the apertures designed for an individual port act together to provide the desired dispersion of fluid.

The above system is very versatile and may be adjusted to meet the requirements of a multitude of applications where direct fluid application is needed. Therefore, the scope of the structure should be determined by the appended claims and their legal equivalents, rather than by the examples presented.

What is claimed is:

1. A system for the delivery of a fluid comprising; a port block comprised of multiple discharge ports where each of the multiple discharge ports has at least two apertures, a fluid source in communication with the at least two apertures, a means to project the fluid from the fluid source through and out of the at least two apertures wherein the fluid may be dispersed through the at least two apertures of one or more of the multiple discharge ports, wherein the fluid is dispersed over an entire pre-determined area when all of the multiple discharge ports are employed, wherein each of the multiple discharge ports are designed to disperse the fluid to a specific discreet location within the entire pre-determined area and an area sensor positioned to detect an event anywhere within the entire pre-determined area upon which the fluid may be dispersed.

2. The system of claim 1 further comprising a manifold positioned to direct the fluid from the fluid source to each of the multiple discharge ports singly or in multiples and at least one valve in fluid communication between the fluid source and the manifold thereby directing the flow of the fluid to the port block and to the at least two apertures of each of the multiple discharge ports.

3. The system of claim 1 wherein the port block is further comprised of a local sensor for each of the multiple discharge ports wherein the local sensor for each of the multiple discharge ports is positioned to detect the event in the specific discreet location upon which each of the multiple discharge ports is positioned to disperse fluid.

4. The system of claim 3 further comprising a logic board in communication with the area sensor, the local sensor for each of the multiple discharge ports and each of the at least one valve wherein the at least one valve is opened upon a signal from the area sensor and the local sensor upon the detection of the event.

5. The system of claim 1 wherein the area sensor is a ultra-violet sensor.

6. The system of claim 3 wherein the local sensor is an infrared sensor.

7. The system of claim 1 wherein the at least two apertures are non-circular in cross-section.

8. A method for the projection of a fluid to a specific location during an event using a system comprised of a port block comprising multiple discharge ports where each of the multiple discharge ports has at least two apertures, a fluid source in communication with the at least two apertures, a sensor to detect the event, a means to project a fluid from the fluid source through and out of the at least two apertures to a pre-determined specific location wherein the multiple discharge ports are positioned and the at least two apertures are designed to direct the fluid to the pre-determined specific location the method comprising; detecting the commencement and the location of the event with the sensor, signaling the commencement and the position of the event to the discharge port positioned to project the fluid to the location, releasing the fluid to the location, sensing the end of the event, signaling the end of the event to the discharge port and halting the releasing of the fluid.

9. The method of claim 8 wherein the system further comprises a manifold positioned to direct the fluid from the fluid source to each of the multiple discharge ports singly or in multiples and a valve in fluid communication between the fluid source and the manifold thereby directing the flow of the fluid to the port block and at least two apertures of each of the multiple discharge ports.

10. The method of claim 8 wherein the port block of the system is rigidly attached to a structure.

11. The method of claim 8 wherein the system further comprises a second sensor for the detection of the event.

12. The method of claim 8 wherein each of the valves is in communication with the sensor and is opened upon a signal from the sensor upon detection of the event.

13. The method of claim 8 wherein the event is fire and the fluid is a fire suppressant.

14. The method of claim 8 wherein the event is ice formation on a surface and the fluid is a deicer.

15. A discharge port for the distribution of a fluid comprising; a port face, a port side perpendicular to the port face, multiple apertures projecting through the port face through which a fluid can be projected wherein the fluid projected through the multiple apertures will cover a specific area.

16. The discharge port of claim 15 further comprising fluid channels wherein the multiple apertures each define an end of one each the fluid channels wherein the fluid channels have an end opposite of the multiple apertures designed to be in fluid communication with a fluid source.

17. The discharge port of claim 15 wherein the channels are non-perpendicular with the port face of the discharge port.

18. The discharge port of claim 15 wherein the multiple apertures are arranged in a symmetrical pattern around a central point on the port face of the discharge port.

19. The discharge port claim 15 wherein the multiple apertures are non-circular in cross-section.

20. The discharge port of claim 16 further comprising a chamber at the end opposite of the multiple apertures designed to be in fluid communication with a fluid source of the channels cable of containing a fluid source.
